(19) United States
(12) Patent Application Publication
(10) Pub. No.: US 2026/0177950 A1
(43) Pub. Date: Jun. 25, 2026

(54) FIXING DEVICE AND IMAGE FORMING APPARATUS INCORPORATING THE SAME

(71) Applicant: ETRIA Co., Ltd., Kanagawa (JP)

(72) Inventor: Hitoshi Fujiwara, Tokyo (JP)

(73) Assignee: ETRIA Co., Ltd., Kanagawa (JP)

(21) Appl. No.: 19/330,101

(22) Filed: Sep. 16, 2025

(30) Foreign Application Priority Data
Dec. 19, 2024 (JP) 2024-223980

(51) Int. Cl. G03G 15/20; G03G 21/16

(52) U.S. Cl. CPC G03G 15/2017; G03G 15/2064; G03G 21/1647; G03G 2215/2035

(57) ABSTRACT

A fixing device includes a heater, a first rotator, a second rotator, a bearing, a bearing holder, and a side plate. The first rotator has an outer circumferential surface. The second rotator includes a rotation shaft extending in an axial direction of the rotation shaft. The second rotator faces the outer circumferential surface of the first rotator to form a fixing nip, through which a recording medium passes, between the first rotator and the second rotator. The bearing rotatably supports the rotation shaft of the second rotator. The bearing holder holds the bearing. The side plate holds the bearing holder. The bearing is relatively movable with respect to one of the bearing holder or the side plate in the axial direction.

### CROSS-REFERENCE TO RELATED APPLICATIONS

This patent application is based on and claims priority pursuant to 35 U.S.C. § 119 (a) to Japanese Patent Application No. 2024-223980, filed on Dec. 19, 2024, in the Japan Patent Office, the entire disclosure of which is hereby incorporated by reference herein.

### BACKGROUND

### Technical Field

The present disclosure relates to a fixing device and an image forming apparatus incorporating the fixing device.

### Related Art

An electrophotographic image forming apparatus includes a fixing device. The fixing device includes a fixing rotator, a pressure rotator pressed against the fixing rotator to form a fixing nip, and a holding structure that holds at least one of the fixing rotator and the pressure rotator. The fixing device fixes a toner image onto a recording medium. The pressure rotator includes a core and an elastic rubber layer on the outer periphery of the core.

### SUMMARY

The present disclosure described herein provides a fixing device including a heater, a first rotator, a second rotator, a bearing, a bearing holder, and a side plate. The first rotator has an outer circumferential surface. The second rotator includes a rotation shaft extending in an axial direction of the rotation shaft. The second rotator faces the outer circumferential surface of the first rotator to form a fixing nip, through which a recording medium passes, between the first rotator and the second rotator. The bearing rotatably supports the rotation shaft of the second rotator. The bearing holder holds the bearing. The side plate holds the bearing holder. The bearing is relatively movable with respect to one of the bearing holder or the side plate in the axial direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a fixing device according to a first embodiment.

FIG. 2 is a schematic diagram illustrating a pressure roller, bearings, bearing covers, and a side plate of the fixing device of FIG. 1;

FIG. 3 is a side view of the fixing device of FIG. 1;

FIG. 4 is a cross-sectional view of a part of the fixing device of FIG. 1 taken along line IV-IV in FIG. 3 to illustrate the side plate, a fixing belt holder, and a fixing belt;

FIG. 5 is a cross-sectional view of another part of the fixing device of FIG. 1 taken along line V-V in FIG. 3 to illustrate an end of a core, the bearing, the bearing cover, and the side plate;

FIG. 6 is a side view of the side plate of the fixing device of FIG. 1;

FIG. 7 is a diagram illustrating an end of a core, a bearing, a bearing cover, and a side plate in a fixing device according to a third embodiment;

FIG. 8 is a diagram illustrating an end of a core, a bearing, a bearing cover, and a side plate having a bent portion in a fixing device according to a fifth embodiment; and

FIG. 9 is a schematic diagram illustrating an image forming apparatus including a fixing device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

A fixing device 100 according to a first embodiment is described below.

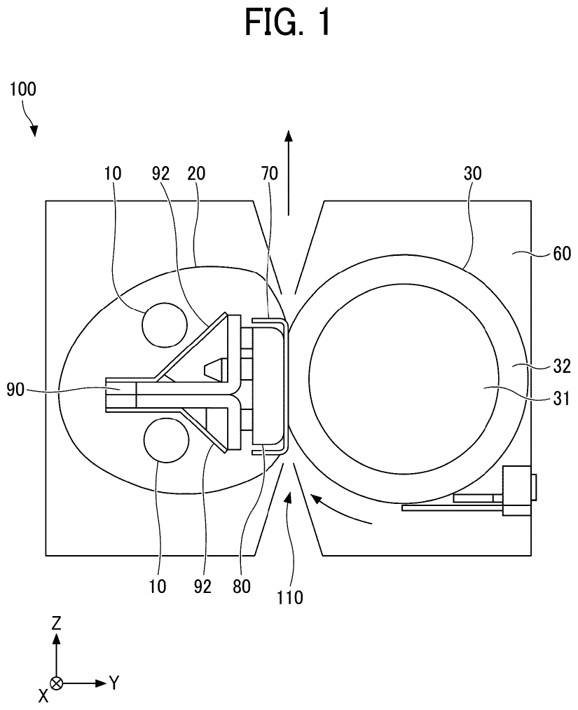

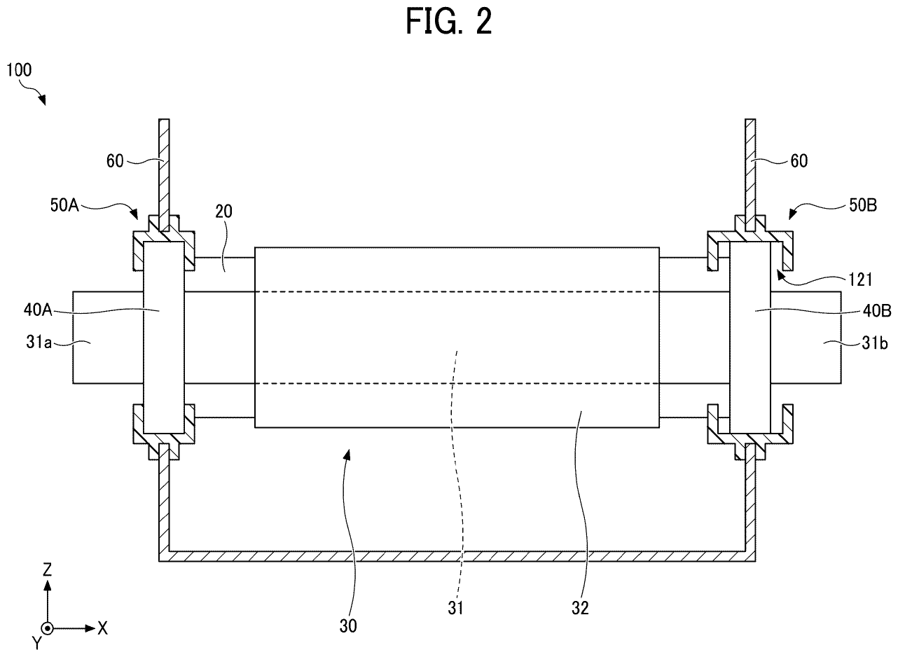

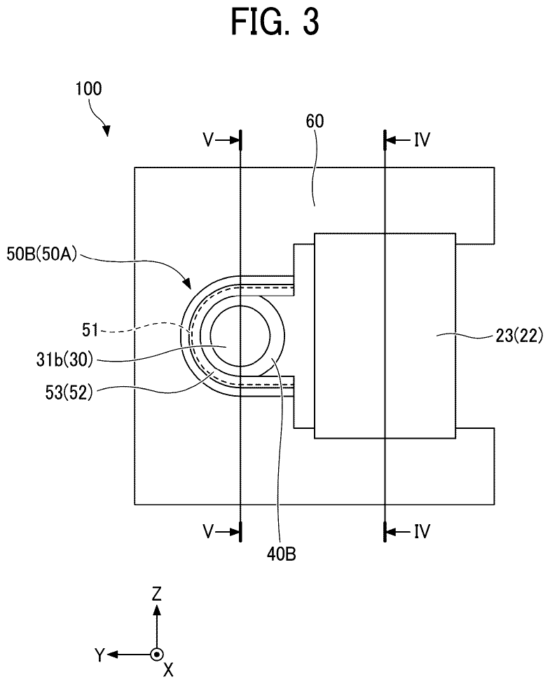

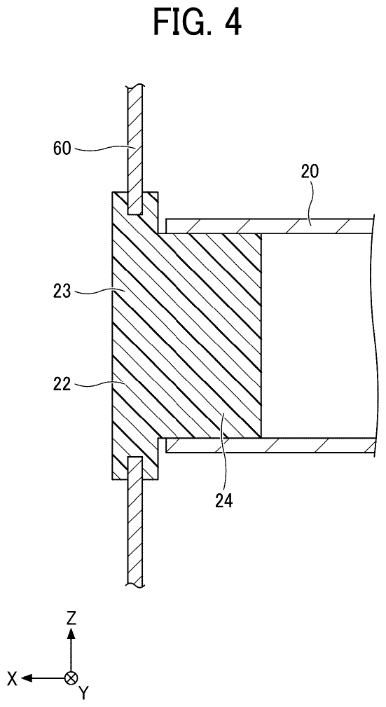

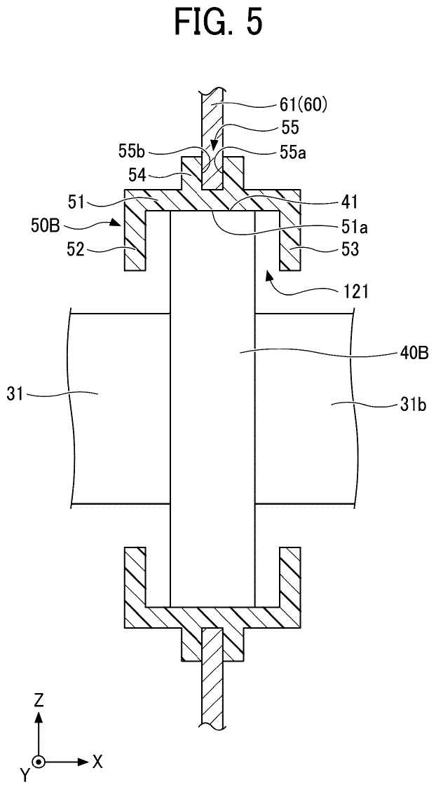

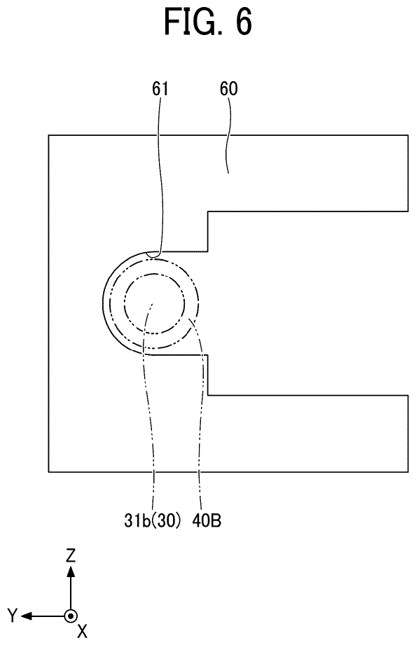

FIG. 1 is a schematic diagram illustrating the fixing device 100. FIG. 2 is a schematic diagram illustrating a pressure roller 30, bearings 40A and 40B, bearing covers 50A and 50B, and a side plate 60 of the fixing device 100. FIG. 3 is a side view of the fixing device 100. FIG. 4 is a cross-sectional view of a part of the fixing device 100 taken along line IV-IV in FIG. 3 to illustrate the side plate 60, a fixing belt holder 22, and a fixing belt 20. FIG. 5 is a cross-sectional view of another part of the fixing device taken along line V-V in FIG. 3 to illustrate an end 31b of a core 31, a bearing 40B, a bearing cover 50B, and the side plate 60. FIG. 6 is a side view of the side plate 60 of the fixing device 100. As illustrated in FIG. 1, the fixing device 100 includes a heater 10, the fixing belt 20, and a pressure roller 30. As illustrated in FIG. 2, the fixing device 100 includes the bearings 40A and 40B, bearing covers 50A and 50B, and the side plate 60.

In each drawing, arrows indicating an X-axis direction, a Y-axis direction, and a Z-axis direction are illustrated. The X-axis direction, the Y-axis direction, and the Z-axis direction are orthogonal to each other. The X-axis direction is an example of a first direction.

The heater 10 is described below.

As illustrated in FIG. 1, the fixing device 100 may include multiple heaters 10. The heaters 10 are disposed inside the loop of the fixing belt 20 to heat the fixing belt 20. The heater 10 may, for example, be a halogen heater. The heater 10 is an example of a heating unit. The heater 10 may, for example, be a planar heater.

The fixing belt 20 is described below.

The fixing belt 20 is an endless belt rotatable about the X axis. As described above, the heater 10 is disposed inside the loop of the fixing belt 20. The heater 10 heats the inner surface of the fixing belt 20 by radiant heat.

As illustrated in FIGS. 3 and 4, the fixing device 100 may include the fixing belt holder 22 to hold the fixing belt 20. The fixing belt holder 22 includes a base portion 23 assembled to the side plate 60 and a holding portion 24 holding the fixing belt 20. The side plate 60 has an opening, and the fixing belt holder 22 is assembled to the opening. The base portion 23 has a plate shape, and the plate thickness direction of the base portion 23 is the same as the plate thickness direction of the side plate 60. The base portion 23 may have a groove into which the edges of the opening in the side plate 60 are inserted.

The holding portion 24 protrudes from the base portion 23 toward the inside of the fixing device 100. The holding portion 24 has an outer circumferential surface contacting the inner surface of the fixing belt 20. The holding portion 24 has, for example, a columnar shape. The holding portion 24 is inserted into the fixing belt 20 and holds an end of the fixing belt 20 in an imaginary rotation axis direction of the fixing belt that is the X-axis direction in FIG. 4. The fixing belt 20 is slidable along the outer circumferential surface of the holding portion 24.

The pressure roller 30 is described below.

As illustrated in FIG. 1, the pressure roller 30 is disposed to face the outer circumferential surface of the fixing belt 20. A fixing nip 110 is formed between the outer circumferential surface of the pressure roller 30 and the outer circumferential surface of the fixing belt 20, and a recording medium passes through the fixing nip 110. The pressure roller 30 and the fixing belt 20 face each other in the Y-axis direction.

As illustrated in FIGS. 1 and 2, the pressure roller 30 includes the core 31 disposed at the center of the pressure roller 30, and a rubber layer 32 disposed on the core 31 in the radial direction of the pressure roller 30. The rubber layer 32 covers the entire outer peripheral surface of the core 31. The outer peripheral surface 30a of the pressure roller 30 is the outer peripheral surface of the rubber layer 32. A release layer may be formed on the surface of the rubber layer 32. The release layer may be made of, for example, perfluoroalkoxy alkane (PFA) or polytetrafluoroethylene (PTFE).

A drive motor is coupled to the pressure roller 30. For example, a gear transmits the rotational driving force of the drive motor to the core 31, which is a rotation shaft of the pressure roller 30. The rotational driving force transmitted from the drive motor rotates the pressure roller 30. The drive motor may be attached to the side plate 60, for example.

The core 31 may be a hollow roller, and a heating unit such as a heater may be disposed inside the core 31. The rubber layer 32 may be made of, for example, solid rubber. Alternatively, if no heater is disposed inside the core 31, the rubber layer 32 may be made of sponge rubber. The heat insulating property of the sponge rubber is higher than the heat insulating property of the solid rubber, and the temperature of the fixing belt 20 is less likely to decrease.

The fixing device 100 may include a pressing mechanism that presses the pressure roller 30 against the fixing belt 20. The pressing mechanism includes a biasing member such as a spring. The biasing member presses the pressure roller 30 against the fixing belt 20. The pressure roller 30 is pressed against the fixing belt 20 in the Y-axis direction. The rubber layer 32 is crushed and deformed. A predetermined nip width is formed between the pressure roller 30 and the heater 10.

A nip formation pad 80 is described below.

As illustrated in FIG. 1, the fixing device 100 includes the nip formation pad 80. The nip formation pad 80 is disposed inside the loop of the fixing belt 20. The nip formation pad 80 is disposed to be in contact with the inner circumferential surface of the fixing belt 20. The nip formation pad 80 forms the fixing nip 110 between the pressure roller 30 and the nip formation pad 80 via a thermal conduction aid 70 and the fixing belt 20. In the fixing nip 110, heat and pressure are applied to the toner image on the recording medium to fix the toner image onto the recording medium.

The thermal conduction aid 70 is described below.

The fixing device 100 includes the thermal conduction aid 70. The thermal conduction aid 70 is disposed inside the loop of the fixing belt 20. The thermal conduction aid 70 may have a flat face in contact with the inner circumferential surface of the fixing belt 20. The thermal conduction aid 70 is contactable to the inner circumferential surface of the fixing belt 20 in the Y-axis direction. The thermal conduction aid 70 has a predetermined width in the X-axis direction. The recording medium is conveyed in the Z-axis direction. The thermal conduction aid 70 has a length corresponding to the width of the recording medium in the X-axis direction. The thermal conduction aid 70 has a face in contact with the inner circumferential surface of the fixing belt 20, and the face may be flat and include a curved face or a recess.

A stay 90 and a reflector 92 are described below.

The fixing device 100 includes the stay 90 and the reflector 92. The stay 90 and the reflector 92 are disposed inside the loop of the fixing belt 20 and extend in the X-axis direction. Both ends of the stay 90 in the longitudinal direction of the stay 90 are fixed to, for example, both sides of the side plate 60. The stay 90 supports the nip formation pad 80.

The fixing device 100 may include multiple reflectors 92. The multiple reflectors 92 are fixed to the stay 90. The reflector 92 has a reflection face that reflects the heat of the heater 10. The reflector 92 is disposed between the heater 10 and the stay 90. The reflector 92 reflects radiant heat from the heater 10 to heat the fixing belt 20. The reflector 92 includes, for example, a surface inclined with respect to the XY plane.

Operation of the fixing belt 20 is described below.

The rotation of the pressure roller 30 is transmitted to the fixing belt 20 and rotates the fixing belt 20. The fixing belt 20 is rotated by the rotation of the pressure roller 30. In the fixing nip 110, the outer circumferential surface of the pressure roller 30 comes into contact with the outer circumferential surface of the fixing belt 20, and the rotational force of the pressure roller 30 is transmitted to the fixing belt 20. When the recording medium is sandwiched between the fixing belt 20 and the pressure roller 30 in the fixing nip 110, the rotational force of the pressure roller 30 is transmitted to the fixing belt 20 via the recording medium.

The fixing device 100 may include a guide that guides the rotation of the fixing belt 20. The guide may be attached to the side plate 60.

The fixing device 100 may include a linear velocity sensor that detects the linear velocity of the fixing belt 20.

The fixing device 100 may include a temperature sensor that detects the temperature of the pressure roller 30.

The fixing device 100 may include a charge neutralization brush as a charge neutralizer that contacts the outer circumferential surface of the pressure roller 30 to remove the charge of the pressure roller 30.

The bearings 40A and 40B are described below.

As illustrated in FIGS. 2, 3, and 5, the fixing device 100 includes a pair of bearings 40A and 40B that rotatably support the rotation shaft of the pressure roller 30. The rotation shaft may be, for example, the core 31. The core 31 has both ends 31a and 31b in the longitudinal direction of the core 31. The bearings 40A and 40B are disposed apart from each other in the X-axis direction. The bearing 40A supports the end 31a, and the bearing 40B supports the end 31b. The bearings 40A and 40B may be, for example, ball bearings. The inner rings of the bearings 40A and 40B are fixed to the core 31. The bearings 40A and 40B may be press-fitted to the core 31. The above-described structure can prevent the occurrence of abnormal noise in the fixing device 100.

The bearing covers 50A and 50B are described below.

The fixing device 100 includes the bearing cover 50A holding the bearing 40A and the bearing cover 50B holding the bearing 40B. As illustrated in FIG. 3, each of the bearing covers 50A and 50B has a U-shape when viewed in the X-axis direction. Each of the bearing covers 50A and 50B has an opening that opens toward the fixing belt 20 in the Y-axis direction.

The bearing covers 50A and 50B have substantially the same structure. However, the bearing cover 50B includes a first position adjuster 121, and the bearing cover 50A does not include the first position adjuster 121. The first position adjuster 121 is described later. The bearing cover 50B is described before the bearing cover 50A is described. The bearing cover 50A may include the first position adjuster 121 and may have the same structure as the bearing cover 50B.

The bearing covers 50A and 50B are made of, for example, an insulating material. The insulating material may be a resin having an insulating property. The bearing covers 50A and 50B made of the insulating material can insulate the side plate 60 from the bearings 40A and 40B. The side plate 60 holds the bearing covers 50A and 50B.

As illustrated in FIG. 5, the bearing cover 50B includes a body plate 51, two flanges 52 and 53, and a set portion 54. The body plate 51 covers the outer peripheral surface of the bearing 40B. The body plate 51 has a U-shape when viewed in the X-axis direction. The thickness direction of the body plate 51 is along the radial direction of the bearing 40B.

The body plate 51 has an inner peripheral face 51a contacting an outer circumferential surface 41 of the bearing 40B. In the radial direction of the bearing 40B, the inner peripheral face 51a faces the outer circumferential surface 41 of the bearing 40B. In the X-axis direction, the width of the inner peripheral face 51a is wider than the width of the outer circumferential surface 41 of the bearing 40B. The bearing cover 50B holds the bearing 40B slidably in the X-axis direction. In other words, the bearing cover 50B as a bearing holder holds the bearing 40B movably in the axial direction of the core 31. The bearing 40B is in contact with the inner peripheral face 51a of the body plate 51 and is slidable in the X-axis direction.

The flanges 52 and 53 are disposed at both ends of the body plate 51 in the X-axis direction and project from the body plate 51 in the radial direction of the bearing 40B. The flanges 52 and 53 protrude from the body plate 51 in a direction approaching the core 31. In the X-axis direction, the flanges 52 and 53 face each other.

In the X-axis direction, the bearing 40B is disposed between the flanges 52 and 53.

In the X-axis direction, the distance between the flanges 52 and 53 is longer than the width of the bearing 40B. The bearing 40B is movable in the X-axis direction between the flanges 52 and 53. The flange 52 is disposed inside the fixing device 100 in the X-axis direction, and the flange 53 is disposed outside the fixing device 100 in the X-axis direction. As illustrated in FIG. 3, each of the flanges 52 and 53 has a U-shape when viewed in the X-axis direction. In other words, the bearing cover 50B includes a holding part including the body plate 51 and the two flanges 52 and 53, and the holding part has a gap with the bearing 40B in the axial direction to allow the bearing 40B to relatively move with respect to the bearing cover 50B as the bearing holder in the axial direction.

As illustrated in FIG. 5, the set portion 54 has a groove 55, and an edge 61 of the opening in the side plate 60 is inserted into the groove 55. The groove 55 is formed along an outer peripheral face of the body plate 51. The set portion 54 includes side walls 55a and 55b facing each other in the X-axis direction. The edge 61 of the opening is inserted into the groove 55 between the side walls 55a and 55b. The edge 61 of the opening is fitted in the groove 55. The edge 61 of the opening has side faces facing each other in the X-axis direction. One side face contacts the side wall 55a, and another side face contacts the side wall 55b. As illustrated in FIG. 6, the opening in the side plate 60 has a U-shape. The edge 61 of the opening includes a peripheral edge of the opening having the U-shape. In FIG. 6, the pressure roller 30 and the bearing 40B are indicated by two dot chain lines.

To assemble the bearing 40B to the side plate 60, sliding the bearing 40B in the Y-axis direction inserts the edge 61 of the opening into the groove 55.

The first position adjuster 121 is described below.

As illustrated in FIG. 5, the bearing cover 50B includes the first position adjuster 121 that can adjust the position of the bearing 40B in the X-axis direction. The first position adjuster 121 has a gap in which the bearing 40B is movable. The first position adjuster 121 includes the body plate 51 and flanges 52 and 53. In the X-axis direction, the bearing 40B is displaceable between the flanges 52 and 53. In the fixing device 100, the position of the bearing 40B in the X-axis direction is adjustable. The bearing 40B is movable in the X-axis direction relative to the side plate 60.

The bearing cover 50A is described below.

Similarly to the bearing cover 50B, the bearing cover 50A includes the body plate 51, the flanges 52 and 53, and the set portion 54. Unlike the bearing cover 50B, the bearing cover 50A does not include the first position adjuster 121. The bearing 40A is sandwiched by the flanges 52 and 53, and the position of the bearing 40A in the X-axis direction is restricted. The bearing 40A is not displaced in the X-axis direction.

A driving force transmission component such as a gear to transmit the rotational driving force to the pressure roller 30 may be disposed at a position close to the bearing 40A that is restricted not to move in the X-axis direction.

The following describes the configuration and effects of the fixing device 100 according to the first embodiment.

The fixing device 100 according to the first embodiment includes the heater 10, the fixing belt 20 as a first rotator, the pressure roller 30 as a second rotator, the bearing 40A or 40B, the bearing cover 50A or 50B as a bearing holder, and the side plate 60. The fixing belt 20 as the first rotator has an outer circumferential surface. The pressure roller 30 as the second rotator includes the core 31 as a rotation shaft extending in the X-axis direction as an axial direction and faces the outer circumferential surface of the fixing belt 20 to form the fixing nip 110 between the fixing belt 20 and the pressure roller 30. A recording medium passes through the fixing nip 110. The bearing 40A or 40B rotatably supports the core 31 of the pressure roller 30. The bearing cover 50B holds the bearing 40B in the axial direction. The side plate 60 holds the bearing cover 50B. In the first embodiment, the first position adjuster 121 causes the bearing 40B to be relatively movable with respect to the bearing cover 50B as the bearing holder.

The fixing device not including the first position adjuster 121 has a disadvantage in that the thermal expansion of the pressure roller in the axial direction under high temperatures causes the bearings press-fitted to the core and fixed to the side plate to move, deforming the side plate outward. In the fixing device 100 according to the first embodiment, when the core 31 thermally expands, the bearing 40B and the bearing cover 50B can displace in the X-axis direction. As a result, the above-described structure can prevent the deformation of the side plate 60 caused by the thermal expansion of the core 31 of the pressure roller 30 in the X-axis direction.

In the fixing device 100 according to the first embodiment, the bearing 40A and the bearing cover 50A are fixed to the side plate 60 to position the bearing 40A in the X-axis direction. The above-described structure can reduce the displacement of a portion close to the bearing 40A in the pressure roller 30 in the X-axis direction to be smaller than that of the structure in which the bearings 40A and 40B can displace in the X-axis direction. The rubber layer 32 of the pressure roller in the fixing device needs to be at a position to which the sheet comes. Reducing the displacement of the pressure roller in the X-axis direction reduces the displacement of the rubber layer of the pressure roller in the X-axis direction. As a result, the above-described structure in the first embodiment can reduce the length of the rubber layer in the X-axis direction, that is, the length of the pressure roller in the axial direction of the pressure roller.

A fixing device 100 according to a second embodiment is described below.

The fixing device 100 according to the second embodiment is different from the fixing device 100 according to the first embodiment in that the bearing cover 50A includes the first position adjuster 121. Both bearing covers 50A and 50B may include the first position adjusters 121.

The fixing device 100 according to the second embodiment also has the same effects as the fixing device 100 according to the first embodiment. In the fixing device 100 according to the second embodiment, both of the bearings 40A and 40B can be displaced in the X-axis direction.

A fixing device 100 according to a third embodiment is described below.

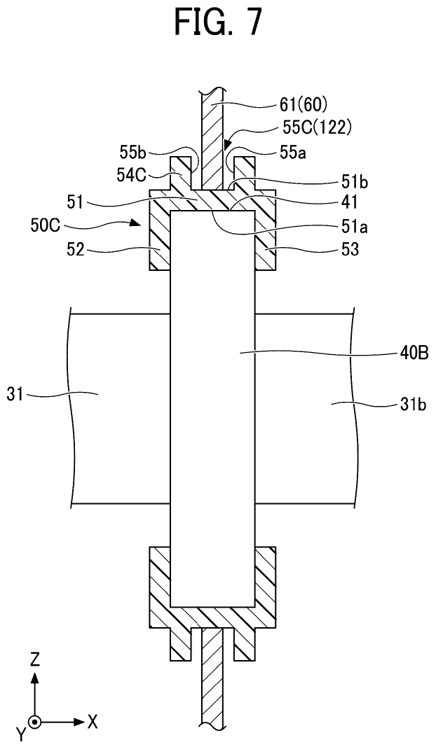

FIG. 7 is a diagram illustrating the end 31b of the core 31, the bearing 40B, and the side plate 60 in the fixing device 100 according to the third embodiment. The fixing device 100 according to the third embodiment is different from the fixing device 100 according to the first embodiment in that the fixing device includes a bearing cover 50C instead of the bearing cover 50B. In the description of the fixing device 100 according to the third embodiment, the same description as that of the fixing device 100 according to the above-described embodiments is omitted.

The fixing device 100 according to the third embodiment includes the bearing cover 50C. The bearing cover 50C holds the bearing 40B. The bearing cover 50C includes the body plate 51, the flanges 52 and 53, and a set portion 54C. The body plate 51 has the inner peripheral face 51a contacting the outer circumferential surface 41 of the bearing 40B. In the X-axis direction, the width of the inner peripheral face 51a is substantially equal to the width of the outer circumferential surface 41 of the bearing 40B.

The flanges 52 and 53 are disposed at both ends of the body plate 51 in the X-axis direction and project from the body plate 51 in the radial direction of the bearing 40B. The flanges 52 and 53 protrude from the body plate 51 in a direction approaching the core 31. In the X-axis direction, the flanges 52 and 53 face each other.

In the X-axis direction, the bearing 40B is disposed between the flanges 52 and 53.

In the X-axis direction, the distance between the flanges 52 and 53 is substantially equal to the width of the bearing 40B. In the X-axis direction, the bearing 40B contacts the flanges 52 and 53. The bearing 40B does not move in the X-axis direction between the flanges 52 and 53.

The set portion 54C has a groove 55C, and the edge 61 of the opening in the side plate 60 is inserted into the groove 55C. The groove 55C is formed along an outer peripheral face 51b of the body plate 51. The set portion 54C includes two side walls 55a and 55b facing each other in the X-axis direction. The edge 61 of the opening is inserted into the groove 55C between the side walls 55a and 55b.

The side walls 55a and 55b face each other in the X-axis direction and project outside from the outer peripheral face 51b of the body plate 51 in the radial direction of the bearing 40B. The side walls 55a and 55b project in a direction away from the bearing 40B.

In the X-axis direction, the distance between the side walls 55a and 55b is longer than the thickness of the side plate 60. The bearing cover 50C is movable in the X-axis direction relative to the side plate 60. In other words, the bearing 40B held by the bearing cover 50C is movable in the X-axis direction relative to the side plate 60.

A second position adjuster 122 is described below.

The bearing cover 50C includes the second position adjuster 122 that can adjust the position of the bearing 40B in the X-axis direction. The second position adjuster 122 has a gap in which the bearing 40B is movable. The second position adjuster 122 has a groove 55C of the set portion 54C. The bearing 40B is movable according to the size of the gap between the side plate 60 and the side wall 55a and the size of the gap between the side plate 60 and the side wall 55b. The bearing cover 50C is displaceable in the X-axis direction until the side plate 60 comes into contact with the side wall 55a or the side wall 55b. The bearing 40B is relatively movable with respect to the side plate 60 in the X-axis direction. In other words, the bearing cover 50C as the bearing holder includes a held part including the body plate 51 and the two side walls 55a and 55b, and the held part has a gap with the side plate 60 in the axial direction to allow the bearing cover 50C as the bearing holder to relatively move with respect to the side plate 60 in the axial direction.

The fixing device 100 according to the third embodiment also has the same effects as the fixing device 100 according to the first embodiment and the second embodiment. In the fixing device 100 according to the third embodiment, the bearing 40B and the bearing cover 50B are displaced integrally.

A fixing device 100 according to a fourth embodiment is described below.

The fixing device 100 according to the fourth embodiment is different from the fixing device 100 according to the third embodiment described above in that the fixing device includes the bearing cover 50C including the second position adjuster 122 instead of the bearing cover 50A holding the bearing 40A. Both the bearing cover 50C holding the bearing 40A and the bearing cover 50C holding the bearing 40B may include the second position adjusters 122.

The fixing device 100 according to the fourth embodiment also has the same effects as the fixing device 100 according to the first to third embodiments. In the fixing device 100 according to the fourth embodiment, both of the bearings 40A and 40B can be displaced in the X-axis direction. The bearings covers 50C holding the bearings 40A and 40B can be made as common parts.

A fixing device 100 according to a fifth embodiment is described below.

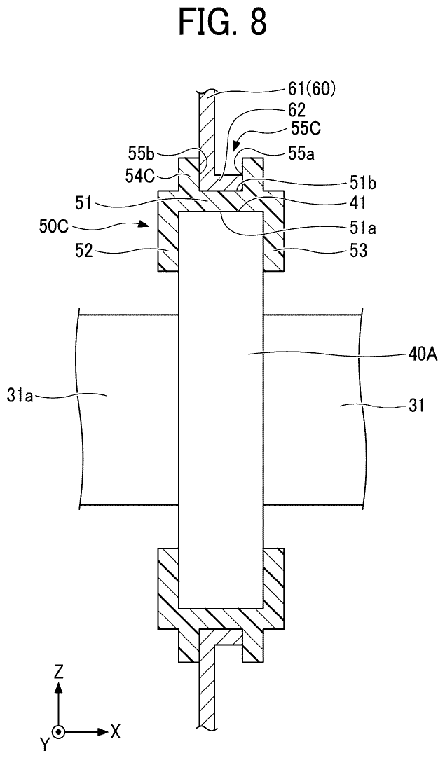

FIG. 8 is a diagram illustrating the end 31a of the core 31, the bearing 40A, the bearing cover 50C, and the side plate 60 having a bent portion 62 in the fixing device 100 according to the fifth embodiment. The fixing device 100 according to the fifth embodiment is different from the fixing device 100 according to the fourth embodiment described above in that the side cover 60 has the bent portion 62 on the edge 61 of the opening that is inserted into the groove 55C of the bearing cover 50C that holds the bearing 40A. In the description of the fixing device 100 according to the fifth embodiment, the same description as that of the fixing device 100 according to the first to fourth embodiments described above is omitted.

A plate thickness direction of the edge 61 of the opening is along the X-axis direction. The bent portion 62 is bent from the tip of the edge 61 of the opening and protrudes in the X-axis direction. A plate thickness direction of the bent portion 62 is along the radial direction of the bearing 40A.

The bent portion 62 comes into contact with the outer peripheral face 51b of the body plate 51. The width of the bent portion 62 in the X-axis direction corresponds to the distance between the side walls 55a and 55b that form the groove 55C. The bent portion 62 is fitted in the groove 55C. As a result, the bearing cover 50C and the bearing 40A are not displaced in the X-axis direction.

The fixing device 100 according to the fifth embodiment also has the same effects as the fixing device 100 according to the first to fourth embodiments. In the fixing device 100 according to fifth embodiment, the bearing covers 50C holding the bearings 40A and 40B can be made as common parts. Since the bent portion 62 is fitted in the groove 55C of the bearing cover 50C holding the bearing 40A, the bearing 40A is not displaced. The above-described structure can reduce the displacement of a portion close to the bearing 40A in the pressure roller 30 in the X-axis direction to be smaller than that of the structure in which the bearings 40A and 40B can displace in the X-axis direction. As described in the first embodiment, the above-described structure in the fifth embodiment can reduce the length of the rubber layer 32 in the X-axis direction, that is, the length of the pressure roller 30 in the axial direction of the pressure roller 30. The fixing device 100 may include, for example, a plate-shaped spacer instead of the bent portion 62. Inserting the spacer into the groove 55C can restrict the movement of the bearing cover 50C and the bearing 40A relative to the side plate 60.

An image forming apparatus 300 including the fixing device 100 according to the above-described embodiments is described below.

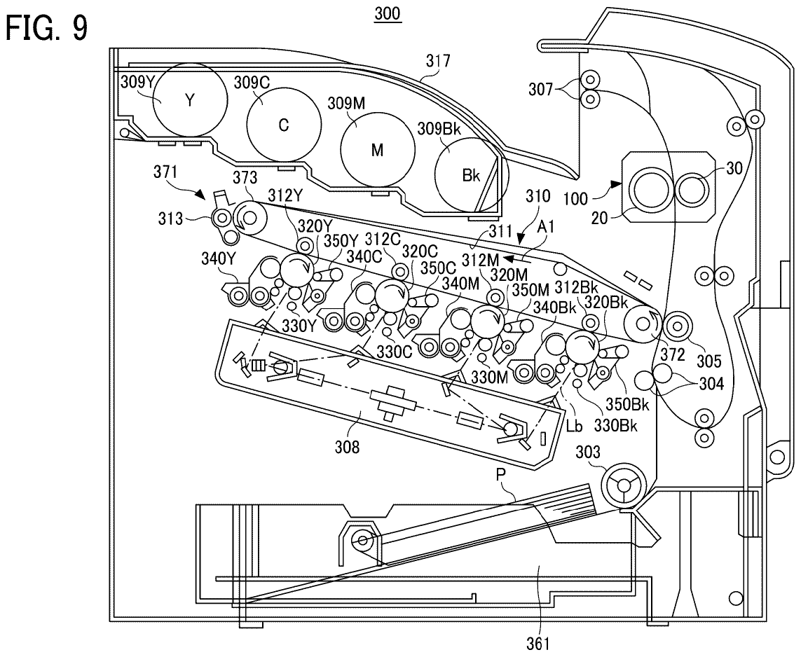

The image forming apparatus 300 is, for example, an electrophotographic color printer. FIG. 9 is a schematic diagram illustrating the image forming apparatus including the fixing device 100.

The image forming apparatus 300 is a tandem type color printer including multiple image forming devices to form multiple color images, and the multiple image forming devices are arranged in a stretch direction of a transfer belt 311 serving as an intermediate transferor. However, the image forming apparatus 300 employing the fixing device 100 according to each of the embodiments is not limited to the printer employing the tandem system. The image forming apparatus employing the fixing device according to each of the embodiments may be a copier or a facsimile machine instead of a printer.

The image forming apparatus 300 employs a tandem structure in which four photoconductor drums 320Y, 320C, 320M, and 320Bk serving as image bearers that bear yellow, cyan, magenta, and black toner images in separation colors, respectively, are arranged side by side.

In the image forming apparatus 300, visible images including the yellow, cyan, magenta, and black toner images formed on the photoconductor drums 320Y, 320C, 320M, and 320Bk, respectively, are primarily transferred successively onto the transfer belt 311 serving as an intermediate transferor that is an endless belt disposed opposite the photoconductor drums 320Y, 320C, 320M, and 320Bk as the transfer belt 311 rotates in a rotation direction A1 such that the yellow, cyan, magenta, and black toner images are superimposed on a same position on the transfer belt 311 in a primary transfer process. Through the primary transfer process, the yellow, cyan, magenta, and black toner images are superimposed on the transfer belt 311 and then secondarily transferred onto a sheet P serving as a recording medium having a sheet form collectively in a secondary transfer process.

Each of the photoconductor drums 320Y, 320C, 320M, and 320Bk is surrounded by image forming units that form the yellow, cyan, magenta, and black toner images on the photoconductor drums 320Y, 320C, 320M, and 320Bk as the photoconductor drums 320Y, 320C, 320M, and 320Bk rotate clockwise in FIG. 9. For example, the photoconductor drum 320Bk to form the black toner image is surrounded by a charger 330Bk, a developing device 340Bk, a primary transfer roller 312Bk, and a cleaning device 350Bk in a rotation direction of the photoconductor drum 320Bk, which perform image formation processing. Similarly, the image forming apparatus 300 includes chargers 330Y, 330C, and 330M, developing devices 340Y, 340C, and 340M, primary transfer rollers 312Y, 312C, and 312M, and cleaning devices 350Y, 350C, and 350M. After the charger 330Bk uniformly charges the photoconductor drum 320Bk, an optical writing device 308 writes an electrostatic latent image on the photoconductor drum 320Bk with a light beam Lb.

As the transfer belt 311 rotates in the rotation direction A1 in FIG. 9, the yellow, cyan, magenta, and black toner images formed on the photoconductor drums 320Y, 320C, 320M, and 320Bk, respectively, are primarily transferred successively onto the transfer belt 311, thus being superimposed on a same position on the transfer belt 311. The primary transfer rollers 312Y, 312C, 312M, and 312Bk disposed opposite the photoconductor drums 320Y, 320C, 320M, and 320Bk, respectively, via the transfer belt 311 apply a voltage to primarily transfer the toner images formed on the photoconductor drums 320Y, 320C, 320M, and 320Bk at different times from the upstream photoconductor drum 320Y to the downstream photoconductor drum 320Bk in the rotation direction A1 of the transfer belt 311.

The photoconductor drums 320Y, 320C, 320M, and 320Bk are arranged in this order from the upstream photoconductor drum 320Y to the downstream photoconductor drum 320Bk in the rotation direction A1 of the transfer belt 311. The photoconductor drums 320Y, 320C, 320M, and 320Bk are located in four image forming stations that form the yellow, cyan, magenta, and black toner images, respectively.

The image forming apparatus 300 includes four imaging stations and a transfer belt unit 310. The four imaging stations form the yellow, cyan, magenta, and black toner images, respectively. The transfer belt unit 310 is disposed opposite and above the photoconductor drums 320Y, 320C, 320M, and 320Bk in FIG. 9. The transfer belt unit 310 includes the transfer belt 311 and the primary transfer rollers 312Y, 312C, 312M, and 312Bk. The image forming apparatus 300 further includes a secondary transfer roller 305 and a belt cleaner 313. The secondary transfer roller 305 is disposed opposite the transfer belt 311 and rotates in accordance with rotation of the transfer belt 311. The belt cleaner 313 is disposed opposite the transfer belt 311 and cleans the transfer belt 311. The optical writing device 308 is disposed opposite and below the four imaging stations in FIG. 9.

The optical writing device 308 includes a semiconductor laser as a light source that writes an electrostatic latent image, a coupling lens, an fθ lens, a toroidal lens, a deflection mirror, and a rotatable polygon mirror serving as a deflector. The optical writing device 308 emits light beams Lb corresponding to the yellow, cyan, magenta, and black toner images to be formed on the photoconductor drums 320Y, 320C, 320M, and 320Bk thereto, forming electrostatic latent images on the photoconductor drums 320Y, 320C, 320M, and 320Bk, respectively. Although FIG. 9 illustrates the light beam Lb directed to the imaging station that forms the black toner image, the light beams Lb are also directed to the imaging stations that form the yellow, cyan, and magenta toner images, respectively.

The image forming apparatus 300 further includes a sheet feeder 361, a registration roller pair 304, and a sensor. The sheet feeder 361 incorporates a paper tray that loads recording media (sheets) P to be conveyed to a secondary transfer nip formed between the transfer belt 311 and the secondary transfer roller 305. The registration roller pair 304 conveys the sheet P conveyed from the sheet feeder 361 to the secondary transfer nip formed between the transfer belt 311 and the secondary transfer roller 305 at a predetermined time when the yellow, cyan, magenta, and black toner images superimposed on the transfer belt 311 reach the secondary transfer nip. The sensor detects a leading edge of the recording medium P as the sheet P that reaches the registration roller pair 304.

The image forming apparatus 300 further includes the fixing device 100, a sheet ejection roller pair 307, an output tray 317, and toner bottles 309Y, 309C, 309M, and 309Bk. The fixing device 100 employing a contact heating system heats the toner images transferred onto the recording medium P and fixes the toner images onto the recording medium P. The sheet ejection roller pair 307 ejects the sheet P bearing the fixed toner images onto an outside of a body of the image forming apparatus 300, that is, the output tray 317. Hereinafter, the color toner image is referred to as the toner image or the image. However, the present embodiment is not limited to printing the color toner image. The image may be a monochrome image. The output tray 317 is disposed atop the image forming apparatus 300 and stacks the recording medium P ejected by the sheet ejection roller pair 307 to the outside of the image forming apparatus 300. The toner bottles 309Y, 309C, 309M, and 309Bk are disposed below the output tray 317 in FIG. 9 and disposed inside the body of the image forming apparatus 300. The toner bottles 309Y, 309C, 309M, and 309Bk are replenished with fresh yellow, cyan, magenta, and black toners, respectively.

In addition to the transfer belt 311 and the primary transfer rollers 312Y, 312C, 312M, and 312Bk, the transfer belt unit 310 includes a drive roller 372 and a driven roller 373 over which the transfer belt 311 is looped.

The driven roller 373 also has a function as a tension applicator to apply tension to the transfer belt 311. For such a function, a biasing member such as a spring is attached to the driven roller 373. The transfer belt unit 310, the primary transfer rollers 312Y, 312C, 312M, and 312Bk, the secondary transfer roller 305, and the belt cleaner 313 construct a transfer device 371.

The sheet feeder 361 is disposed in a lower portion of the body of the image forming apparatus 300. The sheet feeder 361 includes a feed roller 303 that comes into contact with an upper surface of an uppermost sheet P of the sheets P loaded on the paper tray of the sheet feeder 361. As the feed roller 303 is driven and rotated counterclockwise in FIG. 9, the feed roller 303 feeds the uppermost recording medium P to the registration roller pair 304.

The belt cleaner 313 installed in the transfer device 371 includes a cleaning brush and a cleaning blade that are disposed opposite and brought into contact with the transfer belt 311. The cleaning brush and cleaning blade of the belt cleaner 313 scrape and remove a foreign substance such as residual toner from the transfer belt 311, cleaning the transfer belt 311.

The belt cleaner 313 further includes a waste toner conveyor that conveys the residual toner removed from the transfer belt 311 for disposal.

The image forming apparatus 300 includes the fixing device 100 according to each of the embodiments. In the image forming apparatus 300 including the fixing device 100, the deformation of the side plate 60 caused by the thermal expansion of the core 31 of the pressure roller 30 in the X-axis direction can be reduced.

Although the preferred embodiments have been described in detail, the present disclosure is not limited to the above-described embodiments, and various modifications and substitutions can be made to the above-described embodiments without departing from the scope of claims. For example, a fixing device to which the present disclosure can be applied may include a pressure roller as the first rotator and a fixing roller as the second rotator including a rotation shaft.

Aspects of the present disclosure are, for example, as follows.

### First Aspect

In a first aspect, a fixing device includes a heater, a first rotator, a second rotator, a bearing, a bearing holder, and a side plate. The heater heats the first rotator. The first rotator rotates about an axial line extending in a first direction. The second rotator includes a rotation shaft extending in the first direction. The second rotator is disposed to face an outer circumferential surface of the first rotator and form a fixing nip between the outer circumferential surface of the first rotator and the second rotator. A recording medium passes through the fixing nip. The bearing rotatably holds the rotation shaft of the second rotator. The bearing holder holds the bearing. The side plate has portions disposed to be away from each other in the first direction. The portion of the side plate holds the bearing holder. The bearing holder includes a first position adjuster that adjusts a position of the bearing in the first direction.

### Second Aspect

In a second aspect, a fixing device includes a heater, a first rotator, a second rotator, a bearing, a bearing holder, and a side plate. The heater heats the first rotator. The first rotator rotates about an axial line extending in a first direction. The second rotator includes a rotation shaft extending in the first direction. The second rotator is disposed to face an outer circumferential surface of the first rotator and form a fixing nip between the outer circumferential surface of the first rotator and the second rotator. A recording medium passes through the fixing nip. The bearing rotatably holds the rotation shaft of the second rotator. The bearing holder holds the bearing. The side plate has portions disposed to be away from each other in the first direction. The portion of the side plate holds the bearing holder. The bearing holder is held so as to be movable in the first direction with respect to the side plate.

### Third Aspect

In a third aspect, the bearing holder in the fixing device according to the first aspect or the second aspect is made of an insulating material.

### Fourth Aspect

In a fourth aspect, an image forming apparatus including the fixing device according to any one of the first to third aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a heater;
a first rotator having an outer circumferential surface;
a second rotator including a rotation shaft extending in an axial direction of the rotation shaft, the second rotator facing the outer circumferential surface of the first rotator to form a fixing nip, through which a recording medium passes, between the first rotator and the second rotator;
a bearing rotatably supporting the rotation shaft of the second rotator;
a bearing holder holding the bearing; and
a side plate holding the bearing holder,
wherein the bearing is relatively movable with respect to one of the bearing holder or the side plate in the axial direction.

2. The fixing device according to claim 1,
wherein the bearing holder includes a holding part having a gap with the bearing in the axial direction to allow the bearing to relatively move with respect to the bearing holder in the axial direction.

3. The fixing device according to claim 1,
wherein the bearing holder includes a held part having a gap with the side plate in the axial direction to allow the bearing holder to relatively move with respect to the side plate in the axial direction.

4. The fixing device according to claim 2,
wherein the holding part of the bearing holder includes:
a body plate having an inner peripheral face in contact with an outer circumferential surface of the bearing; and
two flanges projecting in the axial direction from both ends of the body plate, toward the rotation shaft of the second rotator in a radial direction of the bearing, and
a distance between the two flanges is longer than a width of the bearing in the axial direction to form the gap between the bearing and each of the two flanges.

5. The fixing device according to claim 3,
wherein the side plate has an opening in which the bearing holder is disposed,
the held part of the bearing holder includes:
a body plate contacting an edge of the opening of the side plate; and
two side walls projecting outward from an outer peripheral face of the body plate in a radial direction of the bearing and forming a groove in which the edge of the opening of the side plate is disposed, and
a distance between the two side walls is longer than a thickness of the side plate in the axial direction to form the gap between the side plate and each of the two side walls.

6. The fixing device according to claim 1,
wherein the bearing holder is made of an insulating material.

7. An image forming apparatus comprising the fixing device according to claim 1.
